(19) United States
(12) Patent Application Publication
(10) Pub. No.: US 2016/0084550 A1
(43) Pub. Date: Mar. 24, 2016

(54) TEMPERATURE MEASURING DEVICE

(71) Applicant: GREENSYSTECH, Bourguébus (FR)

(72) Inventor: Mohamed Papa Talla Fall, Ifs (FR)

(21) Appl. No.: 14/780,727

(22) PCT Filed: Mar. 26, 2014
(86) PCT No.: PCT/EP2014/056087

§ 371 Date: Sep. 28, 2015

(30) Foreign Application Priority Data
Mar. 29, 2013 (FR) 1352951

(51) Int. Cl. F25B 49/02; B60P 3/20; H01M 10/625; G01K 13/00

(52) U.S. Cl. CPC F25B 49/02; G01K 13/00; B60P 3/20; H01M 10/625

(57) ABSTRACT

The present invention relates to a temperature measuring device comprising one or more electricity generator from the group including a temperature difference generator, a vibration generator and a photovoltaic generator; at least one electricity storage element, in particular any of a capacitor, and/or a supercapacitor and/or a battery; and temperature measuring means. The invention further relates to a corresponding system and method, as well as a refrigerated container comprising the temperature measuring device.

### CROSS-REFERENCE TO RELATED APPLICATIONS

This application is a national phase entry under 35 U.S.C. §371 of International Patent Application PCT/EP2014/056087, filed Mar. 26, 2014, designating the United States of America and published in English as International Patent Publication WO 2014/154765 A1 on Oct. 2, 2014, which claims the benefit under Article 8 of the Patent Cooperation Treaty and under 35 U.S.C. §119(e) to France Patent Application Serial No. 1352951, filed Mar. 29, 2013, the disclosure of each of which is hereby incorporated herein in its entirety by this reference.

### TECHNICAL FIELD

The present invention relates to the field of electronics. In particular, the present invention relates to a temperature measuring device.

### BACKGROUND

Electronic devices for monitoring the temperature within a refrigerated container are known. These devices are useful, for instance, in the case of refrigerated transport trucks in order to ensure that the goods contained in the truck are always maintained below a prescribed temperature during the entire transport chain.

### BRIEF SUMMARY

In particular, as visible in FIG. 1, a refrigerated truck 1000 comprises a cabin 1200 and refrigerated storage compartment 1100. In order to ensure that the refrigerated storage compartment 1100 is maintained at a prescribed temperature, a temperature measuring device 1110 is provided. In some cases, the temperature measuring device 1110 is battery operated. This has the disadvantage that batteries have to be periodically replaced in order to ensure the correct working of the device. Additionally, the temperature measuring device 1110 provides a record of the measured temperature during the transport time in the form of a paper ticket. This is not convenient since the temperature measuring 1110 device must then be placed in a position from which the paper ticket can be easily accessed, thereby limiting the possibilities of placement of the temperature measuring device 1110. In some cases, the temperature measuring device 1110 is provided with a cable 1120 for communicating with a recording section, storing the data measured by the measuring device 1110. In these cases, the recording section can be operated by means of the battery available on the truck. However, also in this case, this complicates the placement of the device in that it must be in a position where the cable can be connected.

The above mentioned drawbacks are overcome by the teaching of the present invention in which a temperature measuring device is configured so as to be powered in a manner that does not require constant replacement of batteries. Additionally, in some embodiments of the invention, the transmission of the data from the temperature measuring device can be operated in a wireless manner. Thus, connectivity to the temperature measuring device is improved.

An embodiment of the present invention can relate to a temperature measuring device comprising one or more electricity generator from the group including a temperature difference generator, a vibration generator and a photovoltaic generator; at least one electricity storage element, in particular any of a capacitor and/or a supercapacitor and/or a battery; and temperature measuring means.

Thanks to this arrangement, the temperature measuring device can harvest energy from the environment for its operation, thus operating without the need of constantly replacing the batteries.

In some embodiments, the temperature measuring device can further comprise a memory for storing the temperature values measured by the temperature measuring means.

Thanks to this approach the stored data can be checked so as to confirm that the temperature has been maintained at a prescribed level during the storing of the refrigerated goods. Additionally, the memory allows the data to be stored when power generation is below a predetermined threshold and to be transmitted when power generation is above the predetermined threshold.

In some embodiments, the temperature measuring device can further comprise a communication means for transmitting the temperature values measured by the temperature measuring means.

Thanks to this approach, the data from one or more temperature measuring device can be collected in a single device, such as a manager. Moreover the data can be stored when the manager is removed and connected to a pc to retrieve the recorded data and transmitted when the manager is again visible by the temperature measuring device.

In some embodiments, the temperature measuring device can further comprise a transparent section within a package of the temperature measuring device such that light can pass through the transparent section and reach the photovoltaic generator.

Thanks to this approach the photovoltaic generator can be operated.

In some embodiments, the temperature measuring device can further comprise a first radiator on one side of a package of the temperature measuring device and a second radiator on an opposite side of the package of the temperature measuring device.

Thanks to this approach, the temperature difference on the two sides of the temperature measuring device can be converted into electricity by means of the temperature difference generator. In this case the harvested energy is proportional to the thermal gradient.

An additional embodiment of the invention can further relate to a temperature measuring system comprising one or more temperature measuring device and a manager for receiving and storing the temperature values transmitted by the one or more temperature measuring device.

Thanks to this approach, data can be collected in a single device. Advantageously, the manager can be placed in a location with easier access than the temperature measuring device.

An additional embodiment of the invention can further relate to a refrigerated container, in particular part of a refrigerated vehicle, comprising the temperature measuring device or the temperature measuring system wherein the one or more temperature measuring device is installed on a wall of the refrigerated container.

Thanks to this approach, temperature within the refrigerated container can be monitored.

In some embodiments, the portion of the wall on which the temperature measuring device is installed comprises one or more light conducting region and/or heat conducting region.

Thanks to this approach, operation of the photovoltaic generator and/or of the temperature difference generator can be ensured, even when the temperature measuring device is placed within the refrigerated container.

An additional embodiment of the invention can further relate to a refrigerated container, in particular part of a refrigerated vehicle, comprising the temperature measuring device or the temperature measuring system wherein the one or more temperature measuring device is installed in an opening of a wall of the refrigerated container.

Thanks to this approach, the transparent section can be exposed to the light and one of the radiators of the temperature difference generator can be exposed to the exterior of the refrigerated container, while the other radiator can be exposed to the interior of the refrigerated container.

An additional embodiment of the invention can further relate to a method for powering a temperature measuring device installed within a refrigerated container, in particular part of a refrigerated vehicle, comprising the steps of cooling down the refrigerated container; and converting the thermal difference between the exterior and the interior of the refrigerated container into electricity, so as to power the temperature measuring device.

Thanks to this approach it can be ensured that power is available to the temperature measuring device when temperature measurement is needed, namely when the refrigerated container is turned on.

The invention will be described in more detail by way of example hereinafter using advantageous embodiments and with reference to the drawings. The described embodiments are the only possible configurations in which the individual features may, however, as described above, be implemented independently of each other or may be omitted. Equal elements illustrated in the drawings are provided with equal reference signs. Parts of the descriptions relating to equal elements illustrated in the different drawings may be left out.

### BRIEF DESCRIPTION OF THE DRAWINGS

FIG. 1 schematically illustrates a refrigerated truck 1000 in accordance with the state of the art;

FIG. 2 schematically illustrates a temperature measuring device, a temperature measuring system and a refrigerated truck in accordance with embodiments of the present invention;

FIGS. 3 and 4 schematically illustrate a temperature measuring device in accordance with an embodiment of the present invention; and

FIG. 5 schematically illustrates a thermal electricity generator in accordance with an embodiment of the present invention.

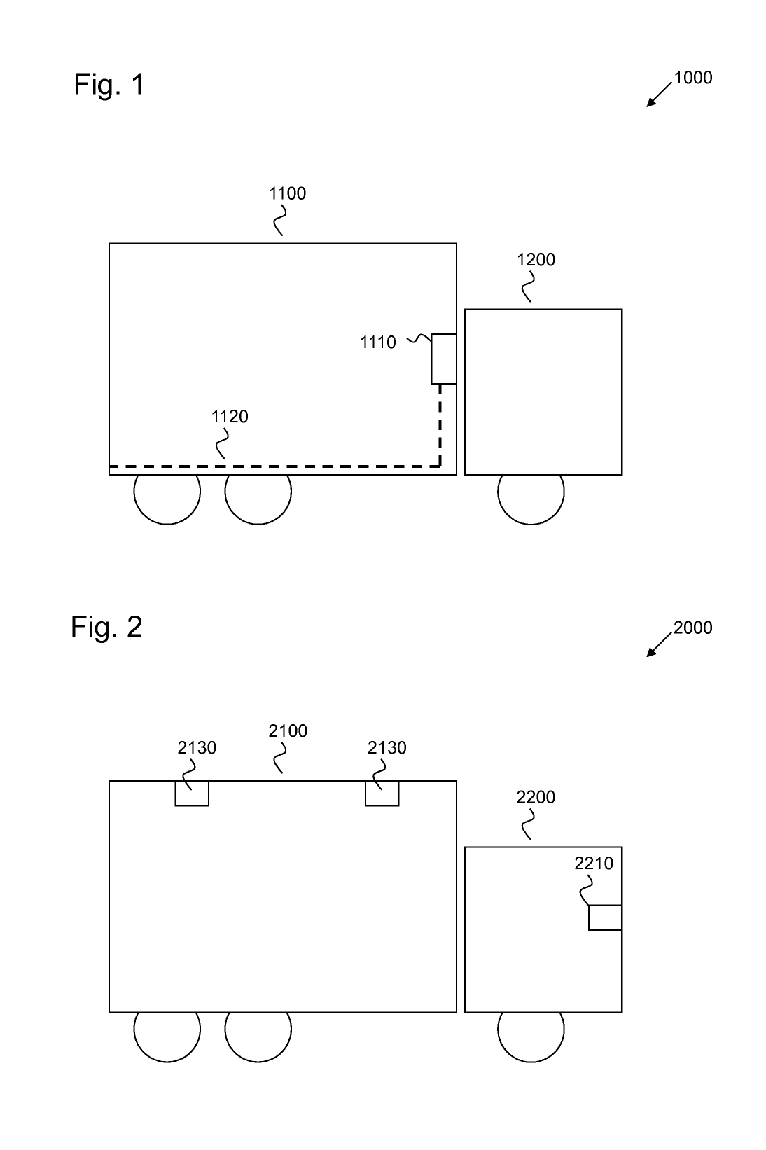

FIG. 2 schematically illustrates a temperature measuring device, a temperature measuring system and refrigerated truck in accordance with an embodiment of the present invention.

### DETAILED DESCRIPTION

In particular, refrigerated truck 2000 comprises one or more temperature measuring device 2130 within the refrigerated storage compartment 2100. Additionally, the truck 2000 comprises one or more manager 2210 within the cabin 2200. The connection between the manager 2210 and any of the temperature measuring devices 2130 is achieved in a wireless manner. Similarly, any of the temperature measuring devices 2130 can be connected to any other of the temperature measuring devices 2130 by a wireless connection. In this manner, the transmission of data between the temperature measuring devices and/or between the temperature measuring devices and the manager can be operated without the presence of a cable connection. Further, the manager is placed in an accessible position and thus data can be retrieved from the manager with a connection, such as a USB connection, which has the advantage of low operation costs.

The manager 2110 is provided with a memory such that the data measured by any of the temperature measuring devices 2130 are transmitted to the manager 2210 can be stored and subsequently transferred to the person in charge of controlling the temperature during transport of the goods.

Any of the managers 2210 and of the temperature measuring devices 2130 can be powered by harvested energy. In particular, among others, they can harvest energy from any of vibration and/or light and/or temperature difference.

In the case of the manager 2210, power can be derived from vibrations due to the movement of the refrigerated truck 2000 transferred to the cabin 2200. Additionally, or alternatively, power can be derived from light reaching into cabin 2200 from the exterior, for instance, through the windscreen. Still additionally, or alternatively, power can be derived from a temperature difference between, for instance, the exterior and the interior of the cabin 2200. The manager 2210 can be mounted, for instance, on the dashboard or the widescreen of cabin 2200 by means of mounting elements such as a magnet or a suction cup.

Similarly, the temperature measuring devices 2130 can be powered by means of vibrations, light and thermal difference between the external and internal part of storage 2100. As explained below, the harvesting of solar energy can be carried out by appropriately placing the temperature measuring device in a position of the storage compartment 2100 where such external light can be received. Similarly, the harvesting of thermal energy can be achieved thanks to the temperature difference between inside and outside of the refrigerated storage compartment 1100. Vibrations can be derived from the movement of the truck 2000. The temperature measuring devices could be mounted on the storage section 2100 by means of screws, magnetic mounts, suction cups, etc.

Any of the temperature measuring devices 2130 and/or manager 2210 could also comprise a memory so as to store the recorded temperature, measured errors, time, etc. The data can be retrieved from the memory by means of a wireless connection, or by a wired connection, such as a USB port in the manager 2210 and/or the temperature measuring device 2130. The memory could be, for instance, 128 Kbytes thereby allowing a logging of 27 days or more for the temperature and the date. The operating temperature of the system comprising the temperature measuring devices 2130 and the manager 2230 can be set in the range of −40° C. to +85° C. and the wireless capabilities of the temperature measuring devices 2130 and of the manager 2210 can be in the range of 50-100 meters, and can be extended to 250 m by doing 5 bounds from sensor to sensor. Preferably, the sensors can work in adhoc mode and each of them transmit the information to the next one, as this implementation is more optimal in terms of energy management. In further embodiments, the range of temperature can be set by using a thermocouple as a temperature sensor, covering temperature range such as:

Max. Thermocouple Resistance; 100Ω

| Thermocouple Type: | Range (° C.) | Resolution | Accuracy |
|---|---|---|---|
| J | −210 to +760 | 0.1° C. | ±0.5° C. |
| K | −270 to +1370 | 0.1° C. | ±0.5° C. |
| T | −270 to +400 | 0.1° C. | ±0.5° C. |
| E | −270 to +980 | 0.1° C. | ±0.5° C. |
| R | −50 to +1760 | 0.5° C. | ±2.0° C. |
| S | −50 to +1760 | 0.5° C. | ±2.0° C. |
| B | +50 to +1820 | 0.5° C. | ±2.0° C. |
| N | −270 to +1300 | 0.1° C. | ±0.5° C. |

Although in the figure described above the temperature measuring system has been illustrated as comprising the manager 2210 and two temperature measuring devices 2130 wherein data from the temperature measuring devices 2130 is transferred to the manager 2210, the present invention is not limited thereto. In some embodiments, the number of temperature measuring devices 2130 could be more than two, for instance, when there are more than two temperatures to monitor. In the simplest possible configuration, the system could comprise only one temperature measuring device 2130 provided with a memory so that data can be stored and read directly from the temperature measuring device 2130 either wirelessly or by means of a cable connection, as described above. In more versatile applications, the system could comprise more temperature measuring devices, so as to track temperature in different locations of the refrigerated storage compartment or in more than one refrigerated storage compartments, and the data could be collected and stored by the manager 2210, to which the personnel in charge of controlling the temperature could connect in order to retrieve the complete set of data from all the temperature measuring devices 2130.

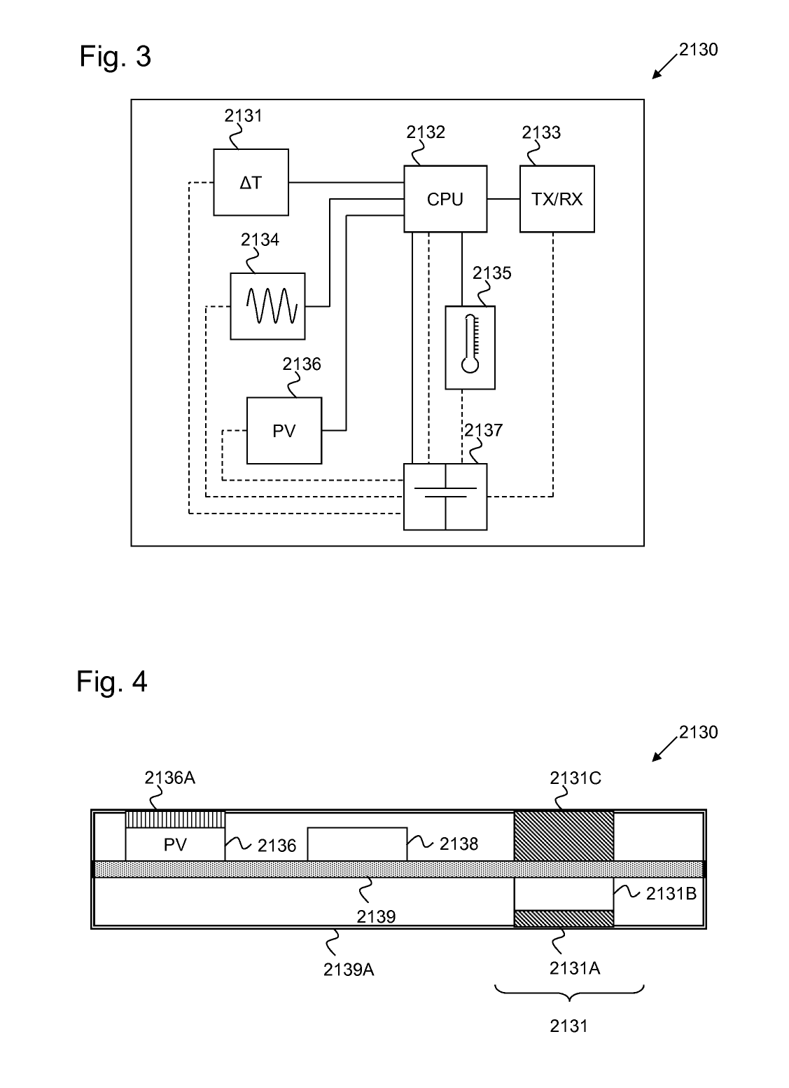

FIG. 3 schematically illustrates the internal structure of a temperature measuring device 2130. The temperature measuring device 2130 illustrated in FIG. 3 comprises means for harvesting energy from temperature differences and/or light and/or vibrations. The present invention is not limited to a temperature measuring device comprising one of each of those harvesting generators and any combination of those three harvesting methods could be used instead. For instance, only the temperature difference harvesting method could be employed. Additionally, the temperature measuring device 2130 illustrated in FIG. 3 comprises a wireless communication section in order to communicate with one or more other temperature measuring device and/or the manager 2210 so as to transfer measured and/or recorded data. Alternatively, or in addition, a memory (not illustrated) could be comprised in the temperature measuring device 2130 in order to store the recorded data. For instance, data could be transferred on a real time basis in the absence of a memory in the temperature measuring device, while data could be transferred in burst of data at predetermined time intervals, 5 minutes in some embodiments, or when the internal memory of the temperature measuring device is full, in the case where the temperature measuring device is provided with a memory.

The temperature measuring device 2130 illustrated in FIG. 3 comprises three energy harvesting elements 2131, 2134 and 2136. More specifically, the three elements are a temperature difference generator 2131, a vibration generator 2134, and a photovoltaic generator 2136. The electricity produced by those three elements is stored in a storage element 2137. This storage element could be, for instance, a battery, a capacitor or a supercapacitor. Also, the storage element could be a combination of different technologies, such as a battery and a supercapacitor. In FIG. 3, dotted lines illustrate a power connection while solid lines illustrate a data connection. The storage element 2137 is used in order to provide power to a temperature measuring means 2135 for measuring the temperature within the refrigerated storage compartment 2100, to a CPU 2132 for controlling the operation of the temperature measuring device 2130 and to a communication means 2133 for communicating with the manager 2210 and/or any other temperature measuring device 2130. As can be seen in FIG. 3, the CPU 2132 is connected to the generators 2131, 2134 and 2136 so that power generation can be efficiently carried out. For instance, if any of the generators are not generating a sufficient amount of power, the CPU may disconnect it from the storage element 2137. Alternatively, or in addition, the CPU can send the corresponding energy to another energy storage (not illustrated) unit in case of multiple storage units or type. Still additionally, or alternatively, if the CPU 2131 recognizes that the amount of charge stored in the storage element 2137 and/or the electricity produced by the three generators 2131, 2134 and 2136 is below a predetermined threshold, the CPU may lower the consumption of the temperature measuring device 2130 by reducing the rate of temperature measurement by means of the temperature measuring means or by temporarily deactivating the communication means 2133 and storing instead the data in a memory within the temperature measuring device (not illustrated).

The communications means 2133 could be, for instance, a wireless module LTP5901 from linear technology. The wireless transmission could be operated in a frequency of 2.45 GHz according to IEEE 802.15.4.

The vibration generator 2134 could operate in a range of frequency from 4-20 Hz. Preferably, the range of frequency is lower than 100 Hz. This is advantageous when combined with the vibrations caused by the movement of the truck 2000. In particular, the vibration generator 2134 could be realized by means of a piezoelectric generator having one or more vibration axis. Advantageously, when more than one axis is present, vibrations could be harvested on more than one direction. This can be preferred in applications, such as a moving truck 2000, where the vibration direction is not always along the same direction. Moreover, the resonance frequency of the piezoelectric generator can be different along the different axis, and can be adjusted, on each axis, by changing the value of the resonant mass, or the length of the suspended arm holding the mass in place.

The temperature measuring means 2135 can be, as described above, a thermocouple or, more generally, any temperature sensing means which can provide a signal to the CPU 2132 representing the temperature.

Although not illustrated, the manager 2210 could be substantially organized in the same manner as the temperature measuring device 2130 except for the lack of the temperature measuring means 2135 and the presence of a memory so as to record data transmitted from the one or more temperature measuring device 2130. Additionally, the manager 2215 could be provided with an interface so as to transfer the data to the final user. This could be achieved, for instance, by means of a wireless transmission or a USB connection.

FIG. 4 schematically illustrates a cut view of a temperature measuring device 2130. As can be seen in FIG. 4, the temperature measuring device 2130 is constructed around a PCB 2139 enclosed within a package 2139A. The package could be, for instance, an IPX7 or IK. Preferably, the package could be an IP67 where the number “6” means totally protected against the dust and the number “7” means water resistant.

The temperature measuring device 2130 comprises the photovoltaic generator 2136 placed on the PCB 2139. The photovoltaic generator 2136 is placed under a transparent section 2136A. In this manner, by placing the transparent section 2136A on a region of the storage compartment 2100 which is exposed to light, the photovoltaic generator 2136 can harvest energy. For instance, the transparent section 2136A could be placed within a wall, preferably within the roof, of the storage compartment 2100 by providing an opening within the wall/roof of the storage compartment 2100. In other words, the temperature measuring device could be integrally inserted into the wall of the refrigerated storage compartment 2100, so as to separate the interior of the refrigerated storage compartment 2100 from the environment outside. Alternatively, or in addition, a corresponding transparent section can be provided within the wall/roof of the refrigerated storage compartment 2100 and the transparent section 2136A can substantially overlap with the transparent section within the wall/roof of the refrigerated storage compartment 2100, such that light can reach the photovoltaic generator 2136.

Moreover, the temperature measuring device 2130 comprises element 2138 which schematically represents at least the CPU 2132, the storage element 2137, and the temperature measuring device 2135. Depending on the configuration chosen, the element 2138 could further comprise the communication means 2133 and/or a memory to record the measured temperatures.

Still further, the temperature measuring device 2130 comprises a temperature difference generator 2131. The temperature difference generator in the embodiment represented in FIG. 4 is organized on the two sides of the PCB 2139. In particular, a first radiator 2131A is placed below the PCB 2139 and under a thermal generator 2131B. A radiator 2131C is placed above the PCB 2139 and on the other side of thermal generator 2131B, opposite to the radiator 2131A. Thanks to this arrangement, the radiator 2131C can be in contact with the wall of the storage container 2100, when the temperature measuring device is mounted on the wall. In this configuration, the region in which the temperature measuring device is mounted can incorporate a heat conducting element, such as a radiator, so as to put the second radiator 2131C thermally in contact with the exterior of refrigerated storage compartment 1100. Alternatively, or in addition, when the temperature measuring device is mounted as an integral part of the wall/roof, within a corresponding opening of the wall/roof, the second radiator 2131C is in direct contact with the exterior of the refrigerated storage compartment 2100, while the first radiator is in direct contact with the interior of the refrigerated storage compartment 2100. In both cases, first radiator 2131A in thermal contact with the interior of storage compartment 2100 will be exposed to a temperature lower than radiator 2131C, in thermal contact with the exterior of the refrigerated storage compartment, due to the refrigerating system acting within storage compartment 2100. Thanks to the difference in temperature between the radiators 2131A and 2131C, the thermal generator 2131B will be able to generate electricity. The thermal generator could be, for instance, a MPGD651 or MPGD751 manufactured by Micropelt.

As described above, the temperature measuring device 2130 can make use of the temperature difference present between the interior and exterior of the refrigerated storage compartment 2100. Moreover, due to the presence of light outside the storage compartment 2100, the photovoltaic generator 2136 can generate electricity. A preferred placement for the temperature measuring device 2130 is on the roof of the storage compartment 2100 as illustrated in FIG. 2. In this case, the transparent section 2136A can receive more light as it faces the sky. At the same time, since the temperature with the storage compartment 2100 will be the warmest on top of the storage compartment 2100, if the temperature in this position is ensured to be below the required threshold, it will be ensured that the temperature within the entire storage container 2100 is below the predetermined threshold. In other words, the present invention is particularly advantageous since it can always ensure generation of electricity when needed. In particular, due to the presence of the temperature difference generator 2131, a generation of electricity is ensured every time a temperature difference is present between radiators 2131A and 2131C, even in the absence of light and vibrations for generators 2134 and 2136. Since the temperature measuring device 2130 is required to operate when the refrigerated truck 2000 is operating, there is a certainty of having a temperature difference between radiators 2131A and 2131C due to the lower temperature forced within the storage compartment 2100. Thus, operation of the temperature measuring device 2130 during at least the time during which the storage compartment 2100 is cooled down, can always be ensured.

Although all elements of the temperature measuring device 2130 have been illustrated as being placed on a single PCB 2139, the present invention is not limited thereto and the package 2139A could actually be composed by a plurality of packages 2139A, connected to each other. For instance, while the temperature sensing means could be placed within the refrigerated storage compartment, all other elements could be placed on the exterior side of the truck 2000. The connection could be achieved by means of cables. Alternatively, or in addition, all elements except the photovoltaic generator could be placed within the refrigerated storage compartment while the photovoltaic generator is placed outside of it. In general, it will be clear to those skilled in the art that while some elements can be advantageously placed inside of the refrigerated storage compartment (such as the temperature sensing means 2135), some others can be advantageously placed outside of the refrigerated storage compartment (such as the photovoltaic generator 2136), while some can be placed wither inside or outside depending on the configuration of the refrigerated storage compartment. For instance, if the temperatures within the refrigerated storage compartment are colder than the outside temperatures, placing the CPU outside of the refrigerated storage compartment could be advantageous, so that electronic components with a smaller working temperature range can be selected, thus lowering the manufacturing costs.

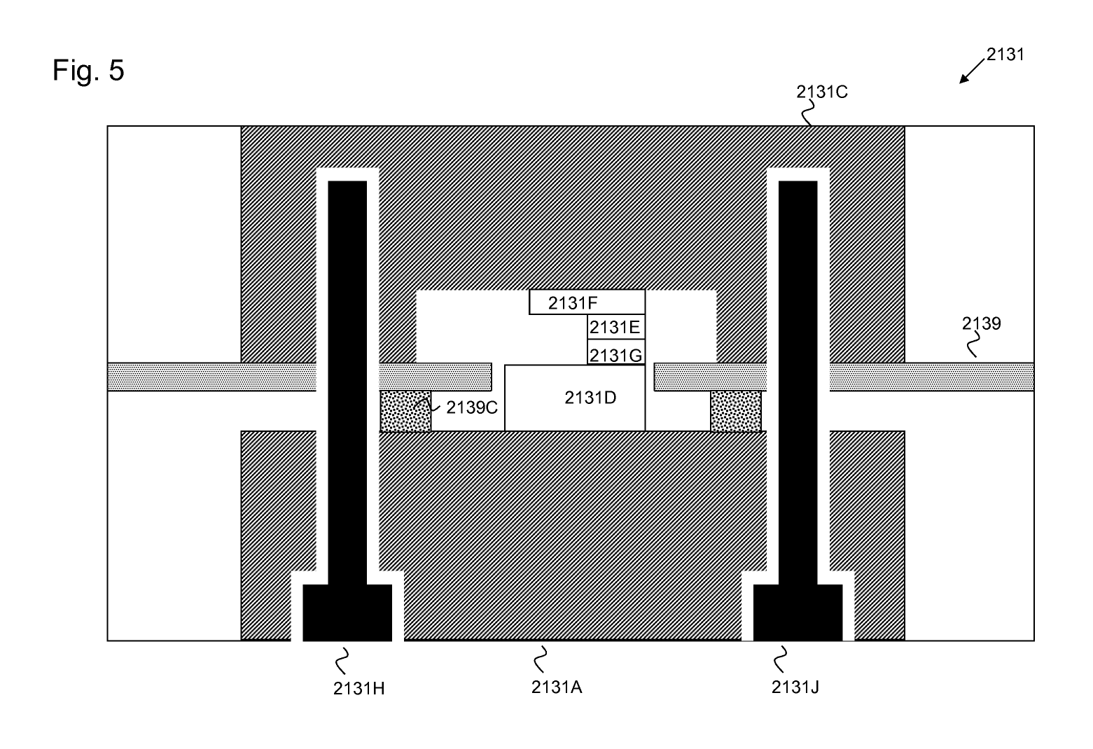

FIG. 5 schematically illustrates an enlarged view of the temperature difference generator 2131.

The two radiators 2131C and 2131A could be square in shape and have a side in the range of 15 to 45 mm, preferably 27 mm. The shape is, however, not necessarily squared and any shape with a substantially equivalent area could be used instead. The lower radiator 2131A is attached to the PCB 2139 by means of an adhesive layer 2139C with a thickness, for instance, in the range of 1 mm, for assembly purpose. However, any fastening means such as, for instance, glue or screws, could be used instead. On the other side of PCB 2139, the second radiator 2131C is connected by means of screw 2131H and 2131J with a diameter of, for instance, 2.1 mm.

The thermal generator 2131B could be comprised of elements 2131D-2131G.

Element 2131D is a metallic element or more generally a heat transferring element which, in some embodiments can be merged with, or part of, or attached to radiator 2131A. The presence of element 2131D is useful for compensating the difference between the thickness of the PCB 2139 and the combined thickness of elements 2131E-2131G.

Elements 2131C and 2131F are, in some embodiments, joined together by a thin heat-conductive glue (not illustrated). Alternately, the elements could be bonded together. Generally, any connection that allows heat transfer is acceptable. Elements 2131E and 2131F are the two cells realizing the thermal electricity generating function. Generally, the warmer cell, in this case 2131F, is bigger than the colder cell, namely 2131E.

Element 2131G avoids the thermal generator to be fixed at two points. In particular, it allows one of the two interfaces, here the interface between elements 2131E and 2131D to absorb the change in position and dimension of the two elements 2131D and/or 2131G due to the change in temperatures. This can be realized, for instance, by employing a TIM (Thermal Interface Material) layer such as Graphite.

While FIG. 5 illustrates screws 2131J and 2131H as being screwed from radiator 2131A into radiator 2131C, the present invention is not limited thereto, and the opposite could also be implemented. Similarly, while element 2131D is illustrated as being placed on the side of radiator 2131A, it could also be placed on the side of radiator 2131C. The same is the case for element 2131F.

Although not illustrated, element 2131A could be shaped in a vertically elongated shape, for instance, as a screw, extending outside of package 2139A. In this manner, the elongated radiator 2131A could penetrate into the refrigerated storage compartment 2100, when the temperature measuring device 2130 is installed on the roof, or more generally, on any exterior wall of the truck 2000. Thanks to this approach, fitting or retrofitting of the temperature measuring device to any existing truck 2000 would be greatly simplified, as it only requires the realization of a hole within any of the walls of the refrigerated storage compartment, such that the elongated radiator 2131A can be inserted therein, so as to be in thermal contact with the interior of the refrigerated storage compartment 2100. It will be apparent to those skilled in the art that this can also be realized by placing an independent heat conductive element in the hole within the walls of the refrigerated storage compartment 2100 and then arranging the temperature measuring device 2130 on the external part of the wall, such that radiator 2131A is in thermal contact with the heat conductive element crossing the wall.

Additionally, while the space around elements 2131D-2131G is illustrated as being empty, in some embodiments it could be filled with a thermally insulating material, so as to force the thermal flux to cross the thermal generator composed by elements 2131E and 2131F. Still additionally, or as an alternative, the PCB 2139 can be elongated until it touches the left and right side of 2131D. In addition to providing mechanical stability to element 2131D (and thus to radiator 2131A, when elements 2131D and 2131A are joined together), this configuration can advantageously use the PCB 2139 as a heat insulating element, forcing the heat flux to cross the thermal generator.

The energy harvested by generators 2131, 2134 and 2136 is stored in storage element 2137 which could be a battery or a supercapacitor. Even when completely depleted, the storage element 2137 can be recharged thanks to the temperature difference created between the interior and exterior of the refrigerated storage compartment 2100. Since the storage compartment has to be refrigerated prior to use, the temperature difference generator 2131 and the storage element 2137 can be sized such that it can be ensured that by the time the storage compartment 2100 is ready for loading with the goods, the temperature difference generator 2131 has generated enough charge within the storage element 2137 sufficient for operating the temperature measuring device 2130 in a minimum mode, such as with a minimum rate of temperature measurement and/or without any wireless communication. In this respect, a memory (not illustrated) could be used in the temperature measuring device such that data can be stored in the memory when low power is available, such as when the truck is not moving and at night, while the recorded data can be transferred in part or totally, when more power is generated during the day or when the truck 2000 is moving.

In some embodiments, the photovoltaic generator 2136 can be used so as to compensate for the leakage of the storage element 2137. That is, the photovoltaic generator and the storage element could be sized and designed such that the storage element leakage during hours with no sunlight can be recovered by the photovoltaic generator during hours with sunlight. Alternatively, or in addition, the storage element could have a constant leakage, which could be replenished on a real time basis by a smaller photovoltaic generator 2136.

Moreover, the recording of the temperature can be configured so as to be started only when a certain predetermined threshold temperature has been achieved, or based on an external input from the manager 2210. In this manner, recording is not carried out while the storage element 2137 is being charged during the cooling down phase of the storage compartment 2100.

Although the present invention has been illustrated with reference to a refrigerated truck 2000, the invention is not limited thereto. While the use in a moving vehicle, such as a refrigerated truck 2000 is advantageous, since it allows the vibration generator 2134 to produce electricity so as to recharge the storage element 2137, the invention could also be used for refrigerating containers which do not move, such as a domestic refrigerator or an industrial refrigerating unit.

Furthermore, in some embodiments, the temperature measuring device can include a vibrational source of energy completed by a battery that can be a coin cell. In this option the function of the battery is to ensure a backup when no vibration occur and the energy stored is consumed. In other words, the vibration generator 2134 and the storage element 2137 realize a first power supply for the temperature sensing means. When no power is generated or stored, the CPU, for instance, a PIC 24F16KA102 microcontroller, switches the power connection of the temperature sensing means to a battery, preferably a coin cell battery. In preferred embodiments, when the storage element 2137 is completely recharged and the vibration generator 2134 still produces electricity, this can be used to recharge the coin battery. This implementation could also be carried out with the photovoltaic generator and/or temperature difference generator.

Moreover, in some embodiments, the storage elements can be multiple. For instance, a storage1 with 50 mF and a storage2 with 500 mF. In this configuration, Storage1 will charge very quickly (i=c*ΔV/Δt and so ΔV=(i/c)*Δt). This will help the temperature measuring device to startup with a minimum energy stored in Storage1 and let the system charge Storage 2 so as to switch to Storage2 when the latter will be completely or sufficiently charged according to the application, for instance, charged at 50%, 75%, 90% or 100%. The optimal ratio Storage2/Storage1 can be chosen according to the best option for each application.

1. A temperature measuring device comprising:
at least one electricity generator selected from the group consisting of a temperature difference generator, a vibration generator and a photovoltaic generator;
at least one electricity storage element comprising any of a capacitor and/or a supercapacitor and/or a battery; and
temperature measuring means.

2. The temperature measuring device according to claim 1, further comprising a memory for storing temperature values measured by the temperature measuring means.

3. The temperature measuring device according to claim 1, further comprising a communication means for transmitting temperature values measured by the temperature measuring means.

4. The temperature measuring device according to claim 1, wherein the at least one electricity generator is a photovoltaic generator, and further comprising a transparent section within a package of the temperature measuring device such that light can pass through the transparent section and reach the photovoltaic generator.

5. The temperature measuring device of claim 1, wherein the at least one electricity generator is a thermal generator, and further comprising a first radiator on one side of a package of the temperature measuring device and a second radiator on an opposite side of the package of the temperature measuring device.

6. A temperature measuring system comprising:
at least one temperature measuring device as recited in claim 3; and
a manager for receiving and storing the temperature values transmitted by the at least one temperature measuring device.

7. A refrigerated container comprising a temperature measuring device as recited in claim 1, wherein the temperature measuring device is installed on a wall of the refrigerated container.

8. The refrigerated container according to claim 7, wherein a portion of the wall on which the temperature measuring device is installed comprises at least one light conducting region and/or at least one heat conducting region.

9. A refrigerated container comprising a temperature measuring device as recited in claim 1, wherein the temperature measuring device is installed in an opening of a wall of the refrigerated container.

10. A method for powering a temperature measuring device installed within a refrigerated container, comprising the steps of:
cooling down the refrigerated container; and
converting a thermal difference between an exterior and an interior of the refrigerated container into electricity, so as to power the temperature measuring device.

11. The temperature measuring device according to claim 2, further comprising a communication means for transmitting temperature values measured by the temperature measuring means.

12. A temperature measuring system comprising:
at least one temperature measuring device as recited in claim 4; and
a manager for receiving and storing the temperature values transmitted by the at least one temperature measuring device.

8. The refrigerated container according to claim 7, wherein a portion of the wall on which the temperature measuring device is installed comprises at least one light conducting region and/or at least one heat conducting region.

13. A temperature measuring system comprising:
at least one temperature measuring device as recited in claim 5; and
a manager for receiving and storing the temperature values transmitted by the at least one temperature measuring device.

14. The refrigerated container of claim 7, wherein the refrigerated container comprises a part of a refrigerated vehicle.

15. The refrigerated container of claim 9, wherein the refrigerated container comprises a part of a refrigerated vehicle.

16. The method of claim 10, wherein the refrigerated container comprises a part of a refrigerated vehicle.

17. A refrigerated container comprising a temperature measuring device as recited in claim 4, wherein the temperature measuring device is installed on a wall of the refrigerated container.

18. A refrigerated container comprising a temperature measuring device as recited in claim 5, wherein the temperature measuring device is installed on a wall of the refrigerated container.

19. A refrigerated container comprising a temperature measuring system as recited in claim 6, wherein the temperature measuring device is installed on a wall of the refrigerated container.

20. The refrigerated container of claim 19, wherein the refrigerated container comprises a part of a refrigerated vehicle.
